(19) United States
(12) Patent Application Publication
(10) Pub. No.: US 2021/0122545 A1
(43) Pub. Date: Apr. 29, 2021

(54) TREATMENT COMPOSITION FOR PACKAGING LINER

(71) Applicant: HEWLETT-PACKARD DEVELOPMENT COMPANY, L.P., Spring, TX (US)

(72) Inventors: Christopher Toles, Escondido, CA (US); Thomas Roger Oswald, Eagle, ID (US); Xulong Fu, San Diego, CA (US); Fereshteh Khorrami, San Diego, CA (US); Julio Cesar Alonso, Temecula, CA (US)

(21) Appl. No.: 16/605,325

(22) PCT Filed: Jul. 12, 2017
(86) PCT No.: PCT/US2017/041754

§ 371 Date: Oct. 15, 2019

(51) Int. Cl. B65D 65/42; C09D 121/02; C09D 191/06; D21H 19/12

(52) U.S. Cl. CPC B65D 65/42; D21H 19/12; C09D 191/06; C09D 121/02

(57) ABSTRACT

An example of a treatment composition for a packaging liner includes a fixing agent, a wax, and a latex. The fixing agent is selected from the group consisting of water-soluble mono-valent metallic salts, water-soluble multi-valent metallic salts, and combinations thereof. A total dry solids content of the example treatment composition ranges from about 5 wt % to about 40 wt % of a total weight of the treatment composition.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. This technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional view of an example of a treated liner disclosed herein, also showing (in phantom) an example of a printed liner;

FIG. 2 is a diagram illustrating an example of a method for producing a treated liner;

FIG. 3 is a diagram illustrating an example of a printing method for producing a printed liner; and

FIG. 4 is a diagram illustrating an example of a method for producing a corrugated paper board.

### DETAILED DESCRIPTION

Inkjet printing is a growing area of digital pre-printing of liners for corrugated packaging. Corrugate pre-print may be undertaken on flexographic or offset printers, or on inkjet-based pre-print technologies (examples of which include the HP T400S and T1100S webpresses).

The corrugation process subjects the components, including the print, to elevated temperatures, on the order of about 350° F. (about 177° C.). Such temperatures can degrade the printed image and result in a reduction of image quality, particularly if the ink is an inkjet ink. The printed surface of the uncoated or coated media is exposed to a heated platen during the corrugation process, and as a result, the surface and the image at the surface may become scratched, scuffed or marked, thereby potentially making it aesthetically displeasing and/or unacceptable to the packaging user. Downstream of the corrugator, handling and transporting printed packaging can also cause damage to the print, potentially making it unattractive to the final customer.

Image quality performance may be measured in terms of the black optical density (KOD or K OD) of a printed image. The term “black optical density,” as referred to herein, is the perceived darkness of a printed image. A higher black optical density equates to a darker colored image and thus, to better image quality performance. The black optical density of a printed image may be equal to the log₁₀ of 1 divided by the reflectance of the printed image (i.e., KOD=log₁₀(1/R), where R is reflectance).

Durability performance may be measured in terms of the abrasion resistance of a printed image. The term “abrasion resistance,” as referred to herein means the ability of a printed image to remain undamaged when rubbed. High abrasion resistance can lead to good durability performance.

Examples of the present disclosure may facilitate digital inkjet pre-printing for packaging applications.

Examples of the present disclosure provide a treatment composition to be applied to an uncoated liner for corrugated packaging applications, which improves the print quality and durability of a printed packaging liner.

The example pre-printed packaging liner(s) exhibit improved durability in the corrugation line which introduces heat, pressure and abrasion to the print side of the liner, as well as exhibiting improved durability in post-production handling. Example(s) of the present disclosure also provide a composition that may be applied to, e.g., a white top liner which may improve the overall print quality (optical density, bleed control, gamut) of the final pre-printed liner and the corrugate made with that pre-printed liner.

In an example, the treatment composition for the packaging liner comprises a fixing agent selected from the group consisting of water-soluble mono-valent metallic salts, water-soluble multi-valent metallic salts, and combinations thereof; a wax; and a latex; wherein a total dry solids content of the treatment composition ranges from about 5 wt % to about 40 wt % of a total weight of the treatment composition. The treatment composition may also include water.

Further, the treatment composition may include additional components. An example of an additional component is a non-ionic dispersant. In an example, the treatment composition further comprises a non-ionic dispersant in an amount ranging from greater than 0 wt % to about 20 wt %, based on the total dry solids content of the treatment composition.

As used herein, a wt % based on the total dry solids content of the treatment composition refers to that component's percentage (by weight) of the total of all the dry components of the treatment composition prior to the addition of water or after water is removed therefrom. In other words, the wt % of any component based on the total dry solids content is the dry parts of that component divided by the total dry parts of all the treatment composition dry components multiplied by 100.

In an example, the treatment composition for the uncoated packaging liner consists of a fixing agent selected from the group consisting of water-soluble mono-valent metallic salts, water-soluble multi-valent metallic salts, and combinations thereof; a wax; a latex; water; and optionally a non-ionic dispersant; wherein a total dry solids content of the treatment composition ranges from about 5 wt % to about 40 wt % of a total weight of the treatment composition. When the treatment composition consists of the fixing agent, the wax, the latex, water, and optionally the non-ionic dispersant, the treatment composition does not include any other components.

Further, in an example, the treatment composition for the uncoated packaging liner consists essentially of: a fixing agent selected from the group consisting of water-soluble mono-valent metallic salts, water-soluble multi-valent metallic salts, and combinations thereof; a wax; a latex; water; and optionally a non-ionic dispersant; wherein a total dry solids content of the treatment composition ranges from about 5 wt % to about 40 wt % of a total weight of the treatment composition. When the treatment composition consists essentially of the fixing agent, the wax, the latex, water, and optionally the non-ionic dispersant, the treatment composition may include other components that do not materially alter or affect the formulation and/or function of the treatment composition.

As mentioned above, the treatment composition includes the fixing agent, which is selected from the group consisting of water-soluble mono-valent metallic salts, water-soluble multi-valent metallic salts, and combinations thereof. In an example, the fixing agent includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, and combinations thereof. Some examples of the cation include sodium, calcium, copper, nickel, magnesium, zinc, barium, iron, aluminum, and chromium, and combinations thereof.

In another example, the fixing agent is a water-soluble multi-valent salt. In these examples, the fixing agent may include (i) a cation of a metal selected from the group consisting of Group II metals, Group III metals, transition metals, and combinations thereof, and (ii) an anion selected from the group consisting of chloride, propionate, iodide, bromide, nitrate, sulfate, sulfite, phosphate, chlorate, acetate, and combinations thereof. Some examples of the fixing agent include calcium chloride, magnesium chloride, calcium bromide, magnesium bromide, calcium nitrate, magnesium nitrate, aluminum chlorohydrate, and combinations thereof. In an example, the fixing agent is calcium chloride (CaCl₂).

In some examples, the fixing agent may have a solubility in water greater than or equal to 15 grams per 100 mL of water at 20° C. and 1 atm pressure. In some other examples, the fixing agent may have a solubility in water greater than or equal to 50 grams per 100 mL of water at 20° C. and 1 atm pressure.

In an example, the fixing agent may be present in the treatment composition in an amount ranging from about 15 wt % to about 70 wt %, based on the total dry solids content of the treatment composition. In another example, the fixing agent may be present in the treatment composition in an amount ranging from about 20 wt % to about 45 wt %, based on the total dry solids content of the treatment composition. In still another example, the fixing agent may be present in the treatment composition at about 35 wt %, based on the total dry solids content of the treatment composition. In yet another example, the fixing agent may be present in the treatment composition at about 65 wt %, based on the total dry solids content of the treatment composition.

A reaction may take place between the fixing agent and an anionic pigment in a liquid ink (applied to a treated liner) to fix the anionic pigment. The fixing agent fixes a printed image in/on the treated liner, where the treatment composition is applied on the liner prior to the application of the liquid ink. As such, image quality (e.g., bleed, coalescence, text quality, etc.) is controlled.

Examples of the treatment composition disclosed herein also include the wax. The wax may serve to provide scratch resistance and friction reduction. In other words, the wax may improve the scratch/rub resistance of the printed liner (having the treatment composition and a liquid ink applied thereon). For example, the wax may provide a print standoff for surface abrasion during the corrugation process. As another example, the wax may provide a print standoff for surface abrasion during shipping and/or normal handling/processing. In other examples of the treatment composition, the wax may not be included.

In some examples, the wax has a median particle size ranging from about 1 μm to about 10 μm. In other examples, the wax has a median particle size ranging from about 5 μm to about 10 μm. As used herein, the term “particle size”, refers to the diameter of a substantially spherical particle (i.e., a spherical or near-spherical particle having a sphericity of >0.84), or the average diameter of a non-spherical particle (i.e., the average of multiple diameters across the particle). Further, as used herein, the term “median particle size”, refers to the D50 or the median diameter of the particle size distribution, where 50% of the population is above the D50 value and 50% is below the D50 value.

The wax that is utilized may depend, in part, upon the temperature of the corrugation process, the melting point of the wax, and formulation of the treatment composition. For example, the wax is compatible with the fixing agent (i.e., the wax is able to remain stable in the treatment composition, which also includes the fixing agent). When a wax is not compatible with a fixing agent, the wax may become destabilized (i.e., may crash out of the treatment composition) in the presence of the fixing agent, which may result in flocculation. Suitable examples of the wax include polypropylene wax, polyethylene wax, polytetrafluoroethylene wax, and the like. In an example, the wax is selected from the group consisting of polypropylene waxes, high density polyethylene (HDPE) waxes, and combinations thereof. In another example, the wax is a polypropylene wax.

An example of a suitable polypropylene wax includes MJU:WAX® 4810 available from Ceronas GmbH & Co., KG (Kastellaun, Germany). MJU:WAX® 4810 is a water insoluble, white powder with a D50 particle size of 7.0 μm, a D90 particle size (i.e., 90% of the population is below this value) of 13 μm, an acid value of 3 mg KOH/g, and a density at 23° C. of 0.96 g/cm³. An example of a suitable high density polyethylene (HDPE) wax is ULTRALUBE® D806 available from Keim-additec Surface GmbH (Kirchberg, Germany). ULTRALUBE® D806 is a water-based, white dispersion with an average particle size of the wax of about 7 μm and a melting point of the wax of about 128° C.

In an example, the wax may be present in the treatment composition in an amount ranging from about 5 wt % to about 40 wt %, based on the total dry solids content of the treatment composition. In another example, the wax may be present in the treatment composition in an amount ranging from about 10 wt % to about 30 wt %, based on the total dry solids content of the treatment composition. In still another example, the wax may be present in the treatment composition in an amount ranging from about 10 wt % to about 20 wt %, based on the total dry solids content of the treatment composition. In yet another example, the wax may be present in the treatment composition at about 20 wt %, based on the total dry solids content of the treatment composition. In yet another example, the wax may be present in the treatment composition at about 7 wt %, based on the total dry solids content of the treatment composition.

Examples of the treatment composition also include a latex. As used herein, the term “latex” refers to a polymer that is capable of being dispersed in an aqueous medium. The latex may act as a binder in the treatment composition. The latex may also improve the scratch/rub resistance of the printed liner (having the treatment composition and a liquid ink applied thereon). For example, the latex may contribute to a print standoff for surface abrasion during the corrugation process. As another example, the latex may contribute to a print standoff for surface abrasion during shipping and/or normal handling/processing.

In an example, the latex is present in the treatment composition in an amount ranging from about 20 wt % to about 50 wt %, based on the total dry solids content of the treatment composition. In another example, the latex is present in the treatment composition in an amount ranging from about 30 wt % to about 45 wt %, based on the total dry solids content of the treatment composition. In still another example, the latex is present in the treatment composition at about 40 wt %, based on the total dry solids content of the treatment composition. In yet another example, the latex is present in the treatment composition at about 23 wt %, based on the total dry solids content of the treatment composition.

The latex that is utilized may depend, in part, upon the formulation of the treatment composition. For example, the latex is compatible with the fixing agent (i.e., the latex is able to remain stable in the treatment composition, which also includes the fixing agent). When a latex is not compatible with a fixing agent, the latex may become destabilized (i.e., crash out of the treatment composition) in the presence of the fixing agent, which may result in the formation of a chunky and friable treatment layer rather than a cohesive treatment layer (that may be formed from the treatment composition when the latex is compatible with the fixing agent).

In an example, the latex is formed from a monomer selected from the group consisting of vinyl monomers, allylic monomers, olefin monomers, unsaturated hydrocarbon monomers, and combinations thereof.

Classes of vinyl monomers include vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylic acid, (meth)acrylates, (meth)acrylamides, (meth)acrylonitriles, and mixtures of two or more of the above, for example. The term “(meth) acrylic latex” includes polymers of acrylic monomers, polymers of methacrylic monomers, and copolymers of the aforementioned monomers with other monomers.

Examples of vinyl aromatic monomers that may form the latex include styrene, 3-methylstyrene, 4-methylstyrene, styrene-butadiene, p-chloro-methylstyrene, 2-chlorostyrene, 3-chlorostyrene, 4-chlorostyrene, divinyl benzene, vinyl naphthalene and divinyl naphthalene. Vinyl halides that may be used include, for example, vinyl chloride and vinylidene fluoride. Vinyl esters of carboxylic acids that may be used include, for example, vinyl acetate, vinyl butyrate, vinyl methacrylate, vinyl 3,4-dimethoxybenzoate, vinyl maleate and vinyl benzoate. Examples of vinyl ethers that may be employed include butyl vinyl ether and propyl vinyl ether.

In some examples, the latex may be a styrene/butadiene latex copolymer (SBR type latex). In some other examples, the latex may be a styrene/butadiene/acrylonitrile latex (ABS type latex). Some examples of the latex polymer/copolymer include aqueous, anionic carboxylated styrene/butadiene copolymer dispersions commercially available under the tradenames LITEX® PX 9710, LITEX® 9720, LITEX® 9730 and LITEX® PX 9740, from Synthomer (Essex, UK), styrene/butadiene/acrylonitrile copolymers commercially available under the tradenames GENCRYL® 9525, GENCRYL® 9750, and GENCRYL® 9780, from Omnova, and/or combination(s) thereof. It has been found that the anionic carboxylated styrene/butadiene copolymer dispersions are tolerant of the fixing agent (i.e., the anionic dispersions do not flocculate or otherwise destabilize in the presence of the fixing agent). This tolerance may be due to a dispersant on the latex that shields it from the fixing agent.

In an example, the treatment composition may further include the non-ionic dispersant. The non-ionic dispersant may be used to disperse the wax particles. In an example, the non-ionic dispersant is present in the treatment composition in an amount ranging from greater than 0 wt % to about 20 wt %, based on the total dry solids content of the treatment composition. In another example, the non-ionic dispersant is present in the treatment composition in an amount ranging from about 4 wt % to about 12 wt %, based on the total dry solids content of the treatment composition. In still another example, the non-ionic dispersant is present in the treatment composition at about 5 wt %, based on the total dry solids content of the treatment composition. An example of the non-ionic dispersant includes SILCO SPERSE™ HLD-6 available from Silcona GmbH & Co., KG (Stromberg, Germany). SILCO SPERSE™ HLD-6 is a non-ionic yellowish, polymeric dispersant with groups of high pigment affinity; total solids: 89.0-91.0%; active agent: 79.0-81.0%; pH Value: 6.5-8.5 (10% in water).

In an example, the treatment composition is devoid of an anionic dispersant. In some instances, the treatment composition may be devoid of an anionic dispersant because an anionic dispersant may react with the cation of the fixing agent, which may in some cases affect the ink pigment-fixing ability of the fixing agent.

In an example, the treatment composition is devoid of a pigment. The treatment composition may be devoid of all pigments (inorganic, organic, plastic, metallic, etc.). In another example, the treatment composition may be devoid of an inorganic pigment, an organic pigment, a plastic pigment, a metallic pigment, or a combination thereof. In an example, the treatment composition may be devoid of pigments to make the treatment composition less viscous and/or easier to apply to a base liner. In another example, the treatment composition may be devoid of pigments to allow for a greater concentration of the fixing agent in a treatment layer (formed from the treatment composition) at the surface of a treated liner so that the fixing agent may fix the ink pigment when a liquid is applied on the treatment layer.

In some examples of the treatment composition, the fixing agent is present in an amount ranging from about 15 wt % to about 70 wt %, based on the total dry solids content of the treatment composition; the wax is present in an amount ranging from about 5 wt % to about 40 wt %, based on the total dry solids content of the treatment composition; and the latex is present in an amount ranging from about 20 wt % to about 50 wt %, based on the total dry solids content of the treatment composition.

The treatment composition also includes water. In an example, deionized water may be used. Water is present in an amount sufficient to achieve the desired wt % of the total dry solids content based on the total weight of the treatment composition. In an example, the treatment composition has a total dry solids content ranging from about 5 wt % to about 40 wt %, based on the total weight of the treatment composition. In another example, the treatment composition has a total dry solids content ranging from about 15 wt % to about 20 wt %, based on the total weight of the treatment composition. In still another example, the treatment composition has a total dry solids content of about 18 wt %, based on the total weight of the treatment composition. As such, the treatment composition may be applied on a base liner during the manufacture of the treated liner.

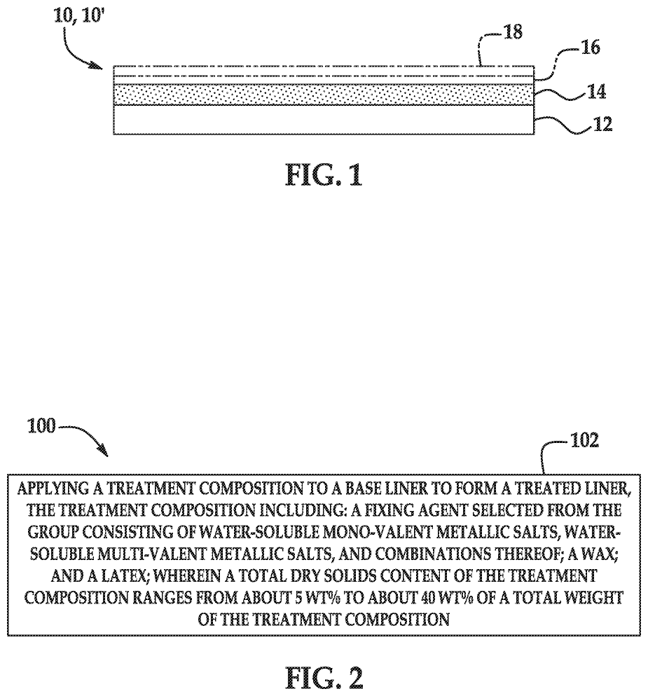

The treatment composition may be used to form a treatment layer of a treated liner for corrugated packaging. An example of the treated liner 10 is shown in FIG. 1.

In an example, the treated liner 10 for corrugated packaging comprises: a base liner 12; and a treatment layer 14 disposed on the base liner 12, the treatment layer 14 including: a fixing agent selected from the group consisting of water-soluble mono-valent metallic salts, water-soluble multi-valent metallic salts, and combinations thereof, wherein the fixing agent is present in an amount ranging from about 15 wt % to about 70 wt %, based on a total weight of the treatment layer 14; a wax in an amount ranging from about 5 wt % to about 40 wt %, based on the total weight of the treatment layer 14; and a latex in an amount ranging from about 20 wt % to about 50 wt %, based on the total weight of the treatment layer 14. In another example, the treatment layer 14 further includes a non-ionic dispersant in an amount ranging from greater than 0 wt % to about 20 wt %, based on the total weight of the treatment layer 14.

In an example, the treated liner 10 consists of the base liner 12 and the treatment layer 14 with no other layers. In other examples, the treated liner 10 may include additional layer(s) (e.g., a curl control layer, a surface sizing layer, etc.).

A printed liner 10′ includes an ink layer 16 (shown in phantom in FIG. 1) fixed on and/or in the treatment layer 14 of the treated liner 10. An over-print varnish layer 18 (also shown in phantom in FIG. 1) may also be included (if desired) on the ink layer 16 on the printed liner 10′.

The base liner 12 of the treated liner 10 acts as a support layer. The base liner 12 provides structural integrity for the resultant treated liner 10. In some examples, the base liner 12 serves as the bottom of the treated liner 10. In other examples the back side of the base liner 12 may coated with a layer (e.g., a curl control layer or another treatment layer). The material of the base liner 12 should have good affinity and good compatibility for the liquid ink that is to be applied to the treated liner 10. As such, the base liner 12 should have the ability to absorb the ink vehicle of the liquid ink (i.e., move the water and/or co-solvent of the ink vehicle away from the treatment layer 14).

The base liner 12 may be made from soft wood and hard wood fibers. It also may be single or multiple-plies. The base liner 12 may also have a sidedness. In an example, the base liner 12 may have a rough side and a smooth side (each relative to the other side of the base liner 12).

The base liner 12 can be either bleached or non-bleached. In an example, the base liner 12 is a white top liner including two ply sheets where the top ply is made of bleached fiber (e.g., bleached eucalyptus kraft fibers), and the bottom ply is made of unbleached fiber (e.g., a mixture of pine and eucalyptus kraft fibers). In another example, the base liner 12 is made of one single ply of bleached fiber. In still another example, the base liner 12 is a kraft liner made from kraft pulp from pines or other conifers. In yet another example, recycled fibers are used to make the base liner 12 which is called Testliner. In yet another example, to improve printability, a minor portion of hardwood fiber may be added to the base liner 12. Any suitable fibers for making liner paper may be used for the base liner 12.

In an example, the base liner 12 is an uncoated liner. In another example, the base liner 12 is an uncoated white top liner. In still another example, the base liner 12 may be a coated liner.

In an example, the base liner 12 is a white top liner and may be made on a paper machine with multiple headboxes or that is otherwise capable of laying down multiple layers of fiber (e.g., through the use of a second fourdrinier machine). When white top liner is used, the top ply provides bleached fiber surface suitable for the application of the treatment composition, and the bottom (non-bleached) ply provides more strength (compared to bleached fibers alone) to the base liner 12.

In some examples, the base liner 12 has a basis weight of about 60 grams per square meter (g/m² or gsm) to about 400 gsm, or about 100 gsm to about 250 gsm. In some examples, the base liner 12 has a basis weight of about 90 grams per square meter (g/m² or gsm) to about 400 gsm, or about 130 gsm to about 250 gsm.

In an example, the base liner 12 may have a thickness along substantially the entire length ranging from about 0.025 mm to about 0.5 mm.

In an example, the treatment composition is coated on the base liner 12 after the manufacturing of the base liner 12 to initiate the formation of the treatment layer 14. Examples of suitable coating techniques include slot die coating, roller coating, fountain curtain coating, blade coating, rod coating, air knife coating, spray coating, coating with a size press, gravure applications, and air brush applications. The coating technique may be an in-line coating technique (e.g., spray coating or coating with a size press) or an offline coating technique (e.g., blade coating or rod coating).

After being applied, the treatment composition on the base liner 12 may be dried to at least substantially remove liquid from the treatment composition to form the treatment layer 14. In an example, the treatment composition may be dried until the treated liner 10 has a predetermined moisture content. For example, the treatment composition may be dried until the treated liner 10 has a moisture content ranging from about 1 wt % to about 8 wt %, or until the treated liner 10 has a moisture content ranging from about 3 wt % to about 7 wt % (based on the total weight of the treated liner 10). In an example, the moisture content may be measured in a nuclear gauge on the paper machine.

As shown in FIG. 1, the treatment layer 14 of the treated liner 10 is disposed on one side of the base liner 12 (e.g., directly on top of the base liner 12). It is to be understood that, as used herein, the terms “formed on”, “disposed on”, “deposited on”, “established on”, and the like are broadly defined to encompass a variety of divergent layering arrangements and assembly techniques. These arrangements and techniques include i) the direct attachment of a layer (e.g., the treatment layer 14) to another layer (e.g., the base liner 12) with no intervening layers therebetween and ii) the attachment of a layer (e.g., the treatment layer 14) to another layer (e.g., base liner 12) with one or more layers therebetween, provided that the one layer being “formed on”, “disposed on”, “deposited on”, or “established on” the other layer is somehow supported by the other layer (notwithstanding the presence of one or more additional material layers therebetween). An example with multiple layers is when the base liner 12 includes multiple plies. Further, the phrases “formed directly on”, “disposed directly on”, “deposited directly on”, “established directly on” and/or the like are broadly defined herein to encompass a situation(s) wherein a given layer (e.g., treatment layer 14) is secured to another layer (e.g., base liner 12) without any intervening layers therebetween. Any statement used herein which indicates that one layer is on another layer is to be understood as involving a situation wherein the particular layer that is “on” the other layer in question is the outermost of the two layers relative to incoming ink materials being delivered by the printing system of interest. It is to be understood that the characterizations recited above are to be effective regardless of the orientation of the treated liner materials under consideration.

In an example of the treated liner 10, the treatment layer 14 is disposed on top of the base liner 12. In another example of the treated liner 10, the treatment layer 14 is disposed directly on top of the base liner 12.

The treatment layer 14 is formed from the treatment composition. As such, the components of the treatment composition (except for water, which is at least substantially removed during drying (e.g., the moisture content of the treated liner 10 may range from about 1 wt % to about 8 wt %, or from about 3 wt % to about 7 wt % based on the total weight of the treated liner 10)) are present in the treatment layer 14 in amounts (in wt % based on the total weight of the treatment layer) about equal to, or equal to the amounts (in wt % based on the total dry solids content of the treatment composition) in the treatment composition. In an example, the treatment layer 14 includes the fixing agent in an amount ranging from about 15 wt % to about 70 wt %, the wax in an amount ranging from about 5 wt % to about 40 wt %, and the latex in an amount ranging from about 20 wt % to about 50 wt %, all based on the total weight of the treatment layer 14.

In an example, the treatment layer 14 may have a coating (coat) weight ranging from about 0.1 gsm to about 6 gsm.

While FIG. 1 shows the treatment layer 14 on the base liner 12, the treatment composition may be absorbed by the base liner 12. Thus, the treatment layer 14 may be within the base liner 12. Further, while the treatment layer 14 is shown as covering all of the base liner 12, the treatment composition may be applied on less than all of the base liner 12, and thus, the treatment layer 14 may cover less than all of the base liner 12.

After drying, the treated liner 10 may further be calendered (either in-line calendered (hard or soft nip), or offline supercalendered) at a suitable speed, temperature, pressure and number of nips to reach a desired thickness (caliper), a desired smoothness, and/or a desired gloss level.

As shown in FIG. 1, in some examples, the treated liner 10 has no layer applied to the other side of the base liner 12 (i.e., a side of the base liner 12 opposed to the one side). In other examples (not shown), the treatment layer 14 is applied to both sides of the base liner 12.

In still other examples (not shown), a curl control layer and/or a surface sizing layer (not shown) may be applied to the side of the base liner 12 opposed to the one side having the treatment layer 14 thereon. The curl control layer may be used to balance the curl of the final product or to improve sheet feeding through printing, overcoat and hot corrugation processes. The curl control layer may include starch. The surface sizing layer may be used to reduce the tendency of the treated liner 10, when dry, to absorb liquid.

Once the treated liner 10 is produced, the treated liner 10 may be wound into a roll. Then the roll of the treated liner 10 may be printed on in an inkjet type printer (e.g., an HP T400S webpress or an HP T1100S webpress) to form the printed liner 10′ and rewound.

As shown in FIG. 1, the treated liner 10 may have an ink layer 16 disposed on the treatment layer 14. The ink layer 16 may be formed by printing a liquid ink on the treatment layer 14. While FIG. 1 shows the ink layer 16 on the treatment layer 14, the liquid ink may be at least partially absorbed by the treatment layer 14 and/or the base liner 12. Thus, the ink layer 16 may be at least partially within the treatment layer 14 and/or the base liner 12. Further, while the ink layer 16 is shown as covering all of the treatment layer 14, the liquid ink may be selectively printed on less than all of the treatment layer 14, and thus, the ink layer 16 may cover less than all of the treatment layer 14.

The liquid ink may include a liquid vehicle and a colorant. The ink may be any color, such as black, cyan, magenta, yellow, etc. In some examples, the ink compositions are inkjet compositions, and as such the ink compositions are well adapted to be used in an inkjet device and/or in an inkjet printing process. The liquid ink may be printed on the treated liner 10 by any suitable inkjet printing technique, such as thermal, acoustic, continuous or piezoelectric inkjet printing.

In some examples, the liquid ink is an aqueous inkjet ink composition, and as such the ink composition includes an aqueous liquid vehicle and a colorant. In some examples, the colorant is selected from a black colorant, a cyan colorant, a magenta colorant, and a yellow colorant. The colorant in the liquid ink may be an anionically dispersed colorant that can react with the fixing agent in the treatment layer 14. The ink vehicle may include water and at least one co-solvent present in an amount ranging from about 1 wt % to about 25 wt % (based on the total weight of the liquid ink). The liquid ink may also contain at least one surfactant/dispersant present in an amount ranging from about 0.1 to about 8 wt %; at least one polymer present in an amount ranging from about 0 to about 6 wt % by total weight of the ink composition. The liquid ink may further include other components common to inkjet inks, such as antimicrobial agents (e.g., biocides and fungicides), anti-kogation agents (for thermal inkjet printing), etc.

In some other examples, the liquid ink may be an anionic ink, such as an anionic pigment-based inkjet ink, an anionic pigmented latex-based inkjet ink, or an anionic UV curable inkjet ink.

As shown in FIG. 1, an over-print varnish layer 18 may be disposed on the ink layer 16. The over-print varnish layer 18 may protect the ink layer 16, and thus, improve the durability of the printed image (printed liner 10′). The over-print varnish layer 18 may also improve the gloss of the printed liner 10′.

The over-print varnish layer 18 may be formed on the ink layer 16 by applying an over-print varnish. Examples of the over-print varnish include INXKOTE® AC911 and INXKOTE® AC9116 from INX International, AQUAFLEX® H.R. from Flint Group, and THERMAGLOSS® 1394E, THERMAGLOSS® 426, THERMAGLOSS® 425, THERMAGLOSS® 475, THERMAGLOSS® 460, and DIGIGUARD® gloss 100 from Michelman.

After forming the ink layer 16 and the over-print varnish layer 18 (when desired), the printed liner 10′ may be used to form corrugated paper board. Corrugated paper board is a material that includes a fluted corrugated sheet/medium (also referred to as a corrugated medium or a fluting/fluted medium) and one or two flat printable package liners, also known as linerboards (as outer layer(s)), which may be the treated liner(s) 10. In an example, the corrugated paper board is a single face medium having one printable package liner thereon. In another example, the fluted corrugated medium is a middle layer, sandwiched between two printable package liners. Corrugated paper board is made on flute lamination machines or corrugators and is used in the manufacture of, for example, shipping containers and corrugated boxes. The fluted corrugated sheet and the base liner 12 of the printable package liners may both be made of kraft containerboard, a paper board material that is usually over 0.01 inches (0.25 mm) thick. The exposed surface(s) of the treated liner(s) 10 is/are printed on (i.e., has an image, text, or the like printed thereon). As such, the ink layer 16 and the over-print varnish layer 18 (when desired) may be disposed on the treated liner 10 to form the printed liner 10′. Then the printed liner(s) 10′ may be assembled with the fluted corrugated sheet in the corrugator.

The printed liner 10′ may be put on the corrugator and joined with a backing layer. The backing layer includes the fluted corrugated sheet and may also include another liner, which may be a printed liner 10′ or a non-printed liner. In an example, the corrugator starts with three liner streams. One of the streams may be turned into the fluted corrugated sheet (e.g., with a corrugating roll) and glued to a liner (the second liner stream, which may be a backside liner and may or may not be a printed liner 10′). Then the printed liner 10′ (the third liner stream) may be glued to the other side of the fluted corrugated sheet. Then the fluted corrugated sheet with the two liners attached thereto may be pressed (e.g., with pressure rolls) against a heated plate to form the corrugated paper board.

In an example, the liner(s) (e.g., the printed liner 10′) may be exposed to a preheater and/or a pressure roll prior to being attached (e.g., glued) to the fluted corrugated sheet. The liners may be exposed to the preheater and/or the pressure roll to prepare the liners to be attached to the fluted corrugated sheet. The preheater and/or the pressure roll may help the gelatization of an adhesive (e.g., glue/starch) used and/or may balance out the moisture content of the liners.

In another example, prior to being turned into the fluted corrugated sheet, the respective liner may be exposed to a pre-conditioner. The pre-conditioner may prepare the respective liner to be corrugated and/or to be attached (e.g., glued) to the exterior (or interior) liners.

After the corrugated paper board is formed, the corrugated paper board may go through a cooling section and/or a triplex, slitting, and scoring section.

Corrugated boxes may include the corrugated paper board, and may be used as shipping containers. These containers may require printing and labels to identify the contents, to provide legal and regulatory information, and to provide bar codes for routing. Boxes that are used for marketing, merchandising and point-of-sale often have high graphics to help communicate the contents. The treated liner 10 disclosed herein provides the boxes with a printable surface.

Also disclosed herein is a method 100 for producing a treated liner 10. An example of the method 100 is shown in FIG. 2.

As shown at reference numeral 102, the method 100 comprises applying the treatment composition to a base liner 12 to form the treated liner 10. The treatment composition, the base liner 12, and their components may be as described above. In an example, the treatment composition, applied to the base liner 12 to form the treated liner 10, includes: a fixing agent selected from the group consisting of water-soluble mono-valent metallic salts, water-soluble multi-valent metallic salts, and combinations thereof; a wax; and a latex; wherein a total dry solids content of the treatment composition ranges from about 5 wt % to about 40 wt % of a total weight of the treatment composition.

In an example of the method 100, the base liner 12 is an uncoated white top liner.

In some examples of the method 100, the applying of the treatment composition is accomplished with a size press, a rod coater, a roll coater, a blade coater, air knife coater, a slot die coater, a fountain curtain coater, a gravure coater, an air brush, or a spray coater. In some examples of the method 100, the applying of the treatment composition is accomplished at a coating speed up to 3000 feet per minute (fpm).

In some examples, the applying of the treatment composition may include applying the treatment composition on one side of the base liner 12 to form the treatment layer 14 on the one side of the base liner 12. In other examples, the applying of the treatment composition may include applying the treatment composition on all, or less than all of one side of the base liner 12. In still other examples, the applying of the treatment composition may include applying the treatment composition on both sides of the base liner 12 to form the treatment layer 14 on both sides of the base liner 12.

In some examples, the method 100 may further include applying a curl control layer composition and/or a surface sizing layer solution to a side of the base liner 12 opposite to the side of the base liner 12 on which the treatment layer 14 was formed. The method 100 may also include drying the curl control layer composition and/or the surface sizing layer solution. The application and drying of the curl control layer composition forms a curl control layer. The application and drying of the curl surface sizing layer solution forms a surface sizing layer. The curl control layer composition may include water and starch, and the surface sizing layer solution may include water and starch, gelatin, and/or acrylic copolymers. In an example, the curl control layer composition and/or the surface sizing layer solution is applied and dried prior to the applying of the treatment composition to form the treatment layer 14.

In some examples of the method 100, the applying of the treatment composition is accomplished in-line or offline. When the applying of the treatment composition is accomplished in-line, the applying of the treatment composition may be applied on the same machine that forms the base liner 12. The base liner may be formed in a paper machine that includes a headbox (containing 99 wt % water and 1 wt % of the base liner material), a wire section (e.g., a fourdrinier screen), a press section, and first drying section to form the base liner. When the treatment composition is applied in-line, the paper machine may further include an application means (e.g., a size press, spray coater, etc.), and a second drying section to form the treatment layer 14 on the base liner 12. The in-line application may depend, in part, upon how fast the paper machine is running and/or the distance between the paper machine and the application means. In an example, the paper machine may further include a calender and/or a reel after the application means and the second drying section.

When the applying of the treatment composition is accomplished offline, the applying of the treatment composition may be applied on a machine that is different than the machine that forms the base liner 12. The base liner 12 may be formed on the paper machine and wound on a roll before being placed on an offline coater (e.g., a blade coater, a rod coater, etc.). In an example, the base liner 12 may be stored after being wound on the roll and prior to being placed on the offline coater.

As mentioned above, the method 100 may further include drying the treatment composition. In an example, the drying of the treatment composition may be accomplished in-line (i.e., on the same machine on which the treatment composition is applied). The amount of time for which the treatment composition is dried may depend, in part, on the wt % of the total dry solids content based on the total weight of the treatment composition and the base liner 12 used.

In an example, the moisture content of the treated liner 10 after drying ranges from about 1 wt % to about 8 wt % (based on the total weight of the treated liner 10). In another example, the moisture content of the treated liner 10 after drying ranges from about 2 wt % to about 5 wt %.

In some examples of the method 100, the method 100 may further include calendering the treatment layer 14. In these examples, the calendering may be accomplished by in-line calendering (hard or soft nip), or by offline supercalendering. The calendering may be accomplished at a suitable speed, temperature, pressure and number of nips to reach a desired smoothness and gloss level.

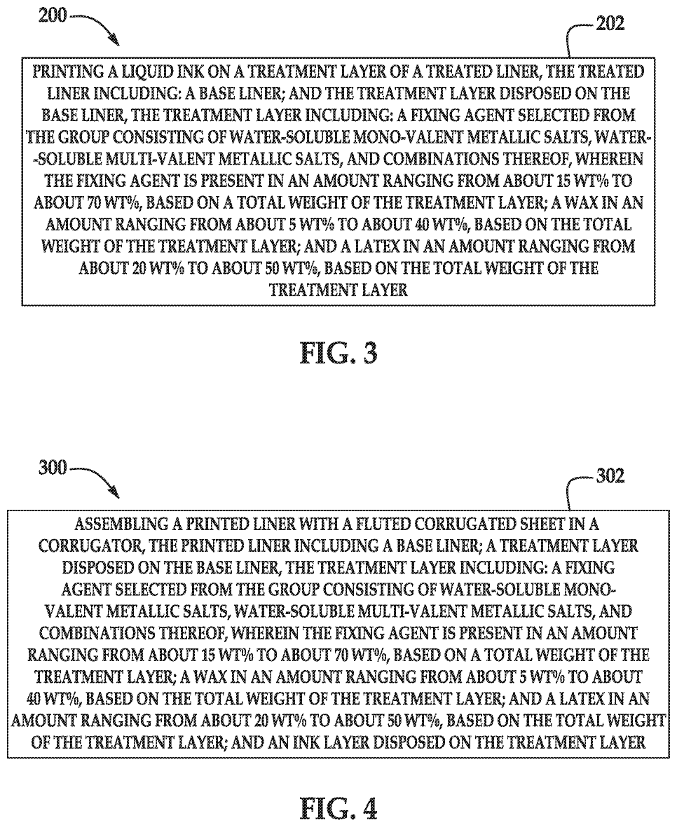

Also disclosed herein is a printing method 200 for producing a printed liner 10′. An example of the method 200 is shown in FIG. 3.

As shown at reference numeral 202, the method 200 comprises printing a liquid ink on a treatment layer 14 of a treated liner 10, the treated liner 10 including: a base liner 12; and the treatment layer 14 disposed on the base liner 12, the treatment layer 14 including: a fixing agent selected from the group consisting of water-soluble mono-valent metallic salts, water-soluble multi-valent metallic salts, and combinations thereof, wherein the fixing agent is present in an amount ranging from about 15 wt % to about 70 wt %, based on a total weight of the treatment layer 14; a wax in an amount ranging from about 5 wt % to about 40 wt %, based on the total weight of the treatment layer 14; and a latex in an amount ranging from about 20 wt % to about 50 wt %, based on the total weight of the treatment layer 14.

The treated liner 10, the liquid ink, and their components may be as described above.

In an example of the printing method 200, the liquid ink may be printed on the treatment layer 14 of the treated liner 10 by any suitable printing process. Examples of printing processes include digital inkjet printing processes, such as thermal, acoustic, continuous or piezoelectric inkjet printing. Some examples of inkjet-based pre-print technologies include the HP T400S and T1100S webpresses.

The printing speed may be any speed up to 600 fpm. Furthermore, In some examples of the method 100, the printing of the liquid ink includes printing 5 or 6 drops per pixel. In some examples of the method 100, the printing of the liquid ink is at about 15 grams per square meter (gsm).

In some examples, the liquid ink is printed in-line with the formation of the treated liner 10. In these examples, the method 200 may be accomplished (i.e., the printing may occur) within milliseconds of producing the treated liner 10 (e.g., by method 100). The treated liner 10 may be partially wet when the liquid ink is printed thereon. For example, the moisture content of the treated liner 10 may range from 0% to about 20% when the liquid ink is printed thereon.

In some examples of the printing method 200, after printing the liquid ink on the treatment layer 14, the method 200 may further include applying an over-print varnish onto the printed ink (i.e., the ink layer 16). The over-print varnish may be as described above.

In some examples, the liquid ink is printed in-line, then dried in-line prior to the in-line application of the over-print varnish. The drying of the over-print varnish may be accomplished by in-line drying the printed liner 10′. The amount of time which the printed ink is dried may depend on the print speed (which may be up to 600 feet per minute (fpm), the color density, color profile, and the base liner 12 used. In an example, the moisture content of the printed liner 10′ after drying ranges from about 1 wt % to about 10 wt % (based on the total weight of the printed liner 10′). In another example, the moisture content of the printed liner 10′ after drying ranges from about 2 wt % to about 5 wt %.

Also disclosed herein is a method 300 for producing a corrugated paper board. An example of the method 300 is shown in FIG. 4.

As shown at reference numeral 302, the method 300 comprises: assembling a printed liner 10′ with a fluted corrugated sheet in a corrugator, the printed liner 10′ including: a base liner 12; a treatment layer 14 disposed on the base liner 12, the treatment layer 14 including: a fixing agent selected from the group consisting of water-soluble mono-valent metallic salts, water-soluble multi-valent metallic salts, and combinations thereof, wherein the fixing agent is present in an amount ranging from about 15 wt % to about 70 wt %, based on a total weight of the treatment layer 14; a wax in an amount ranging from about 5 wt % to about 40 wt %, based on the total weight of the treatment layer 14; and a latex in an amount ranging from about 20 wt % to about 50 wt %, based on the total weight of the treatment layer 14; and an ink layer 16 disposed on the treatment layer 14.

The printed liner 10′, the fluted corrugated sheet, and their components may be as described above.

In some examples of the method 300, a second printed liner may be assembled with the printed liner 10′ and the fluted corrugated sheet. In these examples, the printed liner 10′ may be assembled on one side of the fluted corrugated sheet and the second printed liner may be assembled on a side of the fluted corrugated sheet opposite to the side of the fluted corrugated sheet on which the printed liner 10′ is assembled. The second printed liner may be the same as or similar to the printed liner 10′.

In some other examples of the method 300, a non-printed liner may be assembled with the printed liner 10′ and the fluted corrugated sheet. In these examples, the printed liner 10′ may be assembled on one side of the fluted corrugated sheet and the non-printed liner may be assembled on a side of the fluted corrugated sheet opposite to the side of the fluted corrugated sheet on which the printed liner 10′ is assembled. The non-printed liner may be the same as or similar to the base liner 12 or the treated liner 10.

In some examples of the method 300, one fluted corrugated sheet may be used. In these examples, single layer paper board (i.e., a corrugated paper board with one fluted corrugated sheet) may be produced. The single layer paper board may be a single face board (i.e., a corrugated paper board with one printed liner 10′ attached to one side of the fluted corrugated sheet and no liner attached to the other side of the fluted corrugated sheet; or single wall board (i.e., a corrugated paper board with a liner (e.g., the printed liner) attached to both sides of the fluted corrugated sheet).

In other examples of the method 300, multiple fluted corrugated sheets may be used. In these examples, double layer paper board (i.e., a corrugated paper board with two fluted corrugated sheets also known as double wall board), three layer paper board (i.e., a corrugated paper board with three fluted corrugated sheets also known as triple wall board), etc. may be produced. In these examples, an interior liner may separate the fluted corrugated sheets from each other. In other words, one interior liner may be alternated with the fluted corrugated sheets so that each of the fluted corrugated sheets is attached to an interior liner or an exterior liner and no the fluted corrugated sheet is directly attached to another fluted corrugated sheet. The interior liner(s) may be the same as or similar to the base liner 12 or the treated liner 10.

In some examples, the assembling of the printed liner 10′ with the fluted corrugated sheet is accomplished in-line or offline with the printing of the liquid ink and/or the formation of the treated liner 10.

To further illustrate the present disclosure, an example is given herein. It is to be understood that this example is provided for illustrative purposes and is not to be construed as limiting the scope of the present disclosure.

### Example

Two examples of the treatment composition (labeled E1 and E2) and two comparative example treatment compositions (labeled C1 and C2) were prepared. The general formulations of the example and comparative treatment compositions are shown in Table 1. Each number represents the wt % of each component present in the example and comparative treatment compositions (based on the total dry solids content of the example or comparative treatment composition).

TABLE 1

| | | E1 | E2 | C1 | C2 |
|---|---|---|---|---|---|
| | | (wt % | (wt % | (wt % | (wt % |
| | Specific | of dry | of dry | of dry | of dry |
| Ingredient | Component | solids) | solids) | solids) | solids) |
| Fixing Agent | Calcium Chloride | 35.3 | 65.5 | 100 | 88.75 |
| Wax | MJU: WAX ® | 19.5 | 6.7 | — | 10 |
| | 4810 | | | | |
| Dispersant | SILCO SPERSE ™ | 5 | 5 | — | 1.25 |
| | HLD-6 | | | | |
| Latex | LITEX ® PX 9740 | 40.2 | 22.8 | — | — |

Each of the example and comparative treatment compositions was prepared in a mixer. The dry components were mixed with an amount of water sufficient to prepare the example and comparative treatment compositions, such that each composition had a total dry solids content of about 18 wt % of the total weight of the respective example and comparative treatment compositions. A 400 kg sample of each of the example and comparative treatment compositions was obtained.

Each of the example and comparative treatment compositions was applied to a 42# mottled white top liner (white top liner) from Georgia Pacific and to a 45# brown kraft liner (brown kraft liner) from Georgia Pacific to create example and comparative treated liners. The example treatment compositions were applied to the liners using a metering size press with a 10 mm grooved rod metering at 300 m/min with 0.8 bar pressure on the rod. The comparative example treatment compositions were applied to the liners using a roll applicator with a 25 mm smooth rod metering at 300 m/m in with 1.0 bar pressure on the rod.

A solid black pattern was printed on each of the example and comparative treated liners to create example and comparative printed liners. A solid black pattern was also printed on untreated liners. The example and comparative treated liners and the untreated liners were printed using an HP T400S Web Press (a high-speed, simplex color inkjet web press for corrugated packaging, from HP Inc., Palo Alto, Calif.) and web press inks. The example and comparative treated liners and the untreated liners were printed at a speed of 183 m/min, a dryer setting of 85%, and a normal color profile (i.e., COLOR100_NORMAL_WT42_1_0). Some of the untreated liners had a bonding agent (commercially available as CH602A from HP Inc., Palo Alto, Calif.) digitally applied thereon prior to the ink pattern being printed thereon. The bonding agent is a digitally applied solution that fixes the subsequently applied ink on untreated and uncoated media. The example and comparative printed liners were wound before being tested for durability and optical density.

Each of the example printed liners and each of the comparative printed liners (including the prints created on both the comparative treated liners and the untreated liners) were tested for durability 24 hours after printing using a Sutherland Dry Rub instrument (Paul N. Gardner Co., Inc. Pompano Beach, Fla.). The example and comparative printed liners were rubbed for 100 cycles at an applied weight of 4 lb (i.e., #4 weight). The damage to each of the example and comparative printed liners was graded visually using a scale of 1-5, with 5 indicating no damage seen (best) and 1 indicating that the ink layer was scraped off completely (worst).

The visual grading results of the durability tests for the example and comparative printed liners are shown in Table 2.

TABLE 2

| | | Black print | Black print |
|---|---|---|---|
| | Treatment | on White | on Brown |
| Treated | composition | top liner | kraft liner |
| No | No Bonding Agent | 4 | 4 |
| No | Bonding Agent (BA) | 2 | 2 |
| Yes - No BA | C1 | 1 | 1 |
| Yes - No BA | C2 | 3.5 | 3.5 |
| Yes - No BA | E1 | 4.5 | 5 |
| Yes - No BA | E2 | 3 | 3 |

As shown in Table 2, the prints (i.e., the example printed liners) created on the example treated liners (E1, E2) generally have improved durability over the prints (i.e., the comparative example printed liners) created on the comparative example treated liner (C1) and the untreated liners. The prints on the untreated liner with the bonding agent and the prints with the comparative treatment composition C1 showed streaks of the liner where the ink layer was scraped off. It is believed that the prints created on the untreated white top liner with the bonding agent off may have exhibited suitable durability because the ink pigment was absorbed into the untreated white top liner with the bonding agent off (although this absorption may have also caused the lower optical density values of the prints created on the untreated white top liner with the bonding agent off, as described below). When comparing the durability of the prints created on the comparative treated liner (C2) with the example prints created on the example treated liners (E1, E2), the example prints have comparable (E2) or improved (E2) durability. The print on example treated liner (E1) with less fixing agent, more wax, and latex was significantly improved compared to the comparative treated liner (C2).

The optical density of each of the example printed liners and each of the comparative printed liners (including the prints created on both the comparative treated liners C1, C2 and the untreated liners) was also tested. The optical density of the example and comparative printed liners was measured with an X-Rite 938 transmission/reflection densitometer (X-Rite, Grand Rapids, Mich.) using DEN A settings with the Visual filters for the black prints.

The results of the optical density tests for the example and comparative printed liners are shown in Table 3.

TABLE 3

| | K OD of Black | K OD Black |
|---|---|---|
| Treatment | print on White | print on Brown |
| composition | top liner | kraft liner |
| Untreated | 0.88 | 1.11 |
| (bonding agent off) | | |
| Untreated | 1.25 | 1.26 |
| (bonding agent on) | | |
| C1 | 1.42 | 1.39 |
| (bonding agent off) | | |
| C2 | 1.41 | 1.37 |
| (bonding agent off) | | |
| E1 | 1.27 | 1.30 |
| (bonding agent off) | | |
| E2 | 1.38 | 1.31 |
| (bonding agent off) | | |

As shown in Table 3, the prints created on the example treated liners (i.e., example printed liners) have comparable optical density to the untreated liner with the bonding agent. Thus, a bonding agent would not need to be used with the example treated liners.

Further, while the prints created on the untreated white top liner with the bonding agent off had comparable durability to the example printed liners (see Table 2), the prints created on the untreated white top liner with the bonding agent off also had lower optical density values (as shown in Table 3), which may be undesirable.

When comparing the optical density of the prints created on the comparative treated liners (C1 and C2) with the example prints created on the example treated liners (E1, E2), the example prints have comparable or slightly reduced (but acceptable) optical density, even with the reduced amounts of the fixing agent.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about 5 wt % to about 40 wt % should be interpreted to include not only the explicitly recited limits of from about 5 wt % to about 40 wt %, but also to include individual values, such as 6.01 wt %, 18 wt %, 20 wt %, 30.5 wt %, 37.85 wt %, etc., and sub-ranges, such as from about 5.1 wt % to about 39.5 wt %, from about 15 wt % to about 35 wt %, from about 5.5 wt % to about 30 wt %, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A treatment composition for a packaging liner, comprising:
a fixing agent selected from the group consisting of water-soluble mono-valent metallic salts, water-soluble multi-valent metallic salts, and combinations thereof;
a wax; and
a latex;
wherein a total dry solids content of the treatment composition ranges from about 5 wt % to about 40 wt % of a total weight of the treatment composition.

2. The treatment composition as defined in claim 1, further comprising a non-ionic dispersant in an amount ranging from greater than 0 wt % to about 20 wt %, based on the total dry solids content of the treatment composition.

3. The treatment composition as defined in claim 1 wherein:
the fixing agent is present in an amount ranging from about 15 wt % to about 70 wt %, based on the total dry solids content of the treatment composition;
the wax is present in an amount ranging from about 5 wt % to about 40 wt %, based on the total dry solids content of the treatment composition; and
the latex is present in an amount ranging from about 20 wt % to about 50 wt %, based on the total dry solids content of the treatment composition.

4. The treatment composition as defined in claim 1 wherein the fixing agent includes (i) a cation of a metal selected from the group consisting of Group I metals, Group II metals, Group III metals, transition metals, and combinations thereof, and (ii) an anion selected from the group consisting of chloride, propionate, iodide, bromide, nitrate, sulfate, sulfite, phosphate, chlorate, acetate, and combinations thereof.

5. The treatment composition as defined in claim 1 wherein the wax is selected from the group consisting of polypropylene waxes, high density polyethylene waxes, and combinations thereof.

6. The treatment composition as defined in claim 1 wherein the wax has a median particle size ranging from about 5 μm to about 10 μm.

7. The treatment composition as defined in claim 1 wherein the latex is formed from a monomer selected from the group consisting of vinyl monomers, allylic monomers, olefin monomers, unsaturated hydrocarbon monomers, and combinations thereof.

8. The treatment composition as defined in claim 1 wherein the treatment composition is devoid of an anionic dispersant.

9. The treatment composition as defined in claim 1 wherein the treatment composition is devoid of a pigment.

10. A method for producing a treated liner for corrugated packaging, the method comprising applying the treatment composition of claim 1 to a base liner to form the treated liner.

11. The method as defined in claim 10 wherein the base liner is an uncoated white top liner.

12. The method as defined in claim 10 wherein the applying of the treatment composition is accomplished in-line or offline.

13. A treatment composition for an uncoated packaging liner, consisting essentially of:
a fixing agent selected from the group consisting of water-soluble mono-valent metallic salts, water-soluble multi-valent metallic salts, and combinations thereof;
a wax;
a latex;
water; and
optionally a non-ionic dispersant;
wherein a total dry solids content of the treatment composition ranges from about 5 wt % to about 40 wt % of a total weight of the treatment composition.

14. A treated liner for corrugated packaging, comprising:
a base liner; and
a treatment layer disposed on the base liner, the treatment layer including:
a fixing agent selected from the group consisting of water-soluble mono-valent metallic salts, water-soluble multi-valent metallic salts, and combinations thereof, wherein the fixing agent is present in an amount ranging from about 15 wt % to about 70 wt %, based on a total weight of the treatment layer;
a wax in an amount ranging from about 5 wt % to about 40 wt %, based on the total weight of the treatment layer; and
a latex in an amount ranging from about 20 wt % to about 50 wt %, based on the total weight of the treatment layer.

15. The treated liner as defined in claim 14 wherein the treatment layer further includes a non-ionic dispersant in an amount ranging from greater than 0 wt % to about 20 wt %, based on the total weight of the treatment layer.
